(19) United States
(12) Patent Application Publication
(10) Pub. No.: US 2016/0031054 A1
(43) Pub. Date: Feb. 4, 2016

(54) DUST COLLECTOR FOR COLLECTING SAWDUST AND WOOD CHIPS

(71) Applicant: LEE-CHENG CHANG, TAICHUNG (TW)

(72) Inventor: LEE-CHENG CHANG, TAICHUNG (TW)

(21) Appl. No.: 14/447,646

(22) Filed: Jul. 31, 2014

(51) Int. Cl. B23Q 11/00; B27G 3/00

(52) U.S. Cl. CPC B23Q 11/0046; B27G 3/00

(57) ABSTRACT

A dust collector for collecting sawdust and wood chips is disclosed. The sawdust and wood chips may be extracted from the conduit and the seat to the upper cylinder and the lower cylinder by the exhaust fan motor. The dust collector may collect the sawdust and wood chips adjacent to the ceiling or higher locations while the seat is at the second mode. And the dust collector may also collect the sawdust and wood chips adjacent to the floor or lower locations while the seat is at the first mode. It is easy to operate to turn around the seat to change to the first mode or the second. And the structure is simplified

### FIELD OF THE INVENTION

The present invention relates to dust collector, and more particularly to a dust collector for collecting sawdust and wood chips while using wood working tools.

### BACKGROUND OF THE INVENTION

For many types of machines for processing a workpiece, some means has to be provided to dispense with the grindings, chips, and particulate matter that are generated by the machine during operation. For example, in the case of wood working machines, such as sanders, joiners, and the like, wood that is removed from a workpiece has to be collected and removed from the work area so as to avoid either a breathing hazard for the workman or a fire hazard. More specifically, in the case of portable equipment, such as floor sanders and edgers, it is conventional to draw off the dust that is generated by the machines and then send the air that is carrying the dust into a filter bag arrangement. An alternative technique is to attach a flexible hose or conduit to the dust outlet duct of the machine, and pump the air in the conduit, plus the entrained dust, to a collection station outside. For hand-held and mobile power tools, such as floor sanding equipment, the associated dust collection systems currently in use are cumbersome, impractical, or inadequate.

Two systems are currently in use. In one system, a blower on the machine is used to extract dust from the sanding or cutting operation, and the air and entrained dust go into a filter to collect the dust and filter the air. Work operations have to be suspended frequently to clean the filter and dispose of the collected dust. These maintenance-intense systems blind or clog readily, which reduces the pickup volume at the source, allowing the particulate waste to become airborne or to interfere with the operation. In the second system a flexible hose connects the unit to an external dust collection unit which draws the waste from the tool. These systems do not deliver the necessary air volume to the tool because of intrinsic mechanical problems of delivering air through the extended lengths of flexible tubing. Huge energy requirements and high air velocities are necessary to overcome frictional losses. Frictional losses in ducts increase exponentially with air velocity, so very wide diameter tubing is used.

Please reference to U.S. issued Pat. No. 8,110,025. It is disclosed that a dust collector for collecting sawdust and wood chips during use of wood working tools, which includes a conduit or hose connected through an impeller forcing air with entrained dust and chips to an inlet ring of a single stage dust collector. A particle collector reservoir is connected on the bottom of the inlet ring and a filter element is connected on top of the inlet ring. A tapered ring wall with a central opening is provided in the inlet ring and a baffle is mounted in the central opening of the ring wall.

However, the above mentioned dust collector can only easily extract the sawdust and wood chips adjacent to the floor or lower locations. If the sawdust and wood chips adjacent to the ceiling or higher locations, the above mentioned dust collector must change much longer conduit or hose to perform or lift up the whole dust collector higher. It is hard to be operated and dangerous.

### SUMMARY OF THE INVENTION

An objective of this invention is providing a dust collector. The sawdust and wood chips may be extracted from the conduit and the seat to the upper cylinder and the lower cylinder by the exhaust fan motor. The dust collector may collect the sawdust and wood chips adjacent to the ceiling or higher locations while the seat is at the second mode. And the dust collector may also collect the sawdust and wood chips adjacent to the floor or lower locations while the seat is at the first mode. It is easy to operate to turn around the seat to change to the first mode or the second. And the structure is simplified.

To achieve above objectives, a dust collector is provided and comprises: a base; two supports, arranged on the base and spaced apart from each other; a hollow removal seat, removably arranged on the two supports, the seat including a connecting hole and a connecting ring disposed at opposite two sides thereof; an exhaust fan motor, arranged at one side of the connecting hole and communicating with the seat; and a conduit, arranged at opposite side of the connecting hole and communicating with the seat; wherein the exhaust fan motor is at upper position and the conduit is at lower position while the seat is at a first mode, and the exhaust fan motor is at lower position and the conduit is at upper position while the seat is removed from the two supports and turned around to fix at the two supports and then the seat is at a second mode.

The dust collector may further comprise an upper cylinder, a lower cylinder and a L-shaped bar, the L-shaped bar is always arranged at upper side of the seat whatever at the first mode or at the second mode, the upper cylinder is detachably communicated with the connecting ring and always at the upper side of the seat whatever at the first mode or the second mode, and the lower cylinder is detachably communicated with the connecting ring and at the lower side of the seat whatever at the first mode or the second mode, the upper cylinder is made by an air permeable material and hanged by the L-shaped bar.

Wherein each side of the seat may include two pairs of screw holes and one insertion hole, the two pairs of the screw holes at lower side of the seat are fixed with the two supports respectively at the first mode or the second mode with two pairs of screws, the insertion hole at lower side of the seat at the first mode or the second mode is plugged by a insertion stopper, the two pairs of the screw holes at upper side of the seat are plugged by two pairs of stoppers, and the insertion hole at the upper side of the seat is provided for fastening the L-shaped bar.

The dust collector may further comprise a wheel assembly arranged at the lower side of the base.

Wherein the upper cylinder and the lower cylinder are detachably fastened at the connecting ring by a cable tie respectively.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a dust collector at a first mode according to an embodiment of present invention.

FIG. 2 is a partial perspective view of the dust collector at the first mode according to an embodiment of present invention.

FIG. 3 is a partial exploded view of the dust collector at the first mode according to an embodiment of present invention.

FIG. 4 is a perspective view of a dust collector at a second mode according to an embodiment of present invention.

FIG. 5 is a partial perspective view of the dust collector at the second mode according to an embodiment of present invention.

FIG. 6 is a partial exploded view of the dust collector at the second mode according to an embodiment of present invention.

### DESCRIPTION OF THE PREFERRED EMBODIMENT

Referring now to the drawings where like characteristics and features among the various figures are denoted by like reference characters.

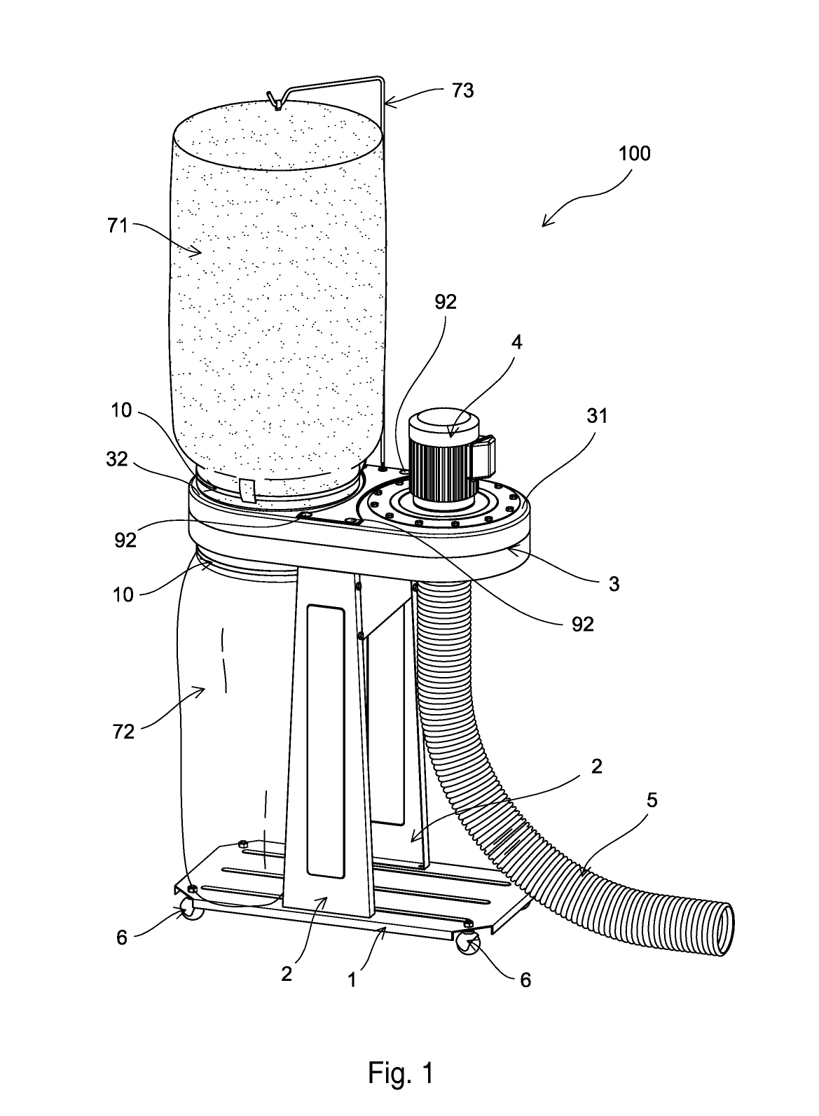

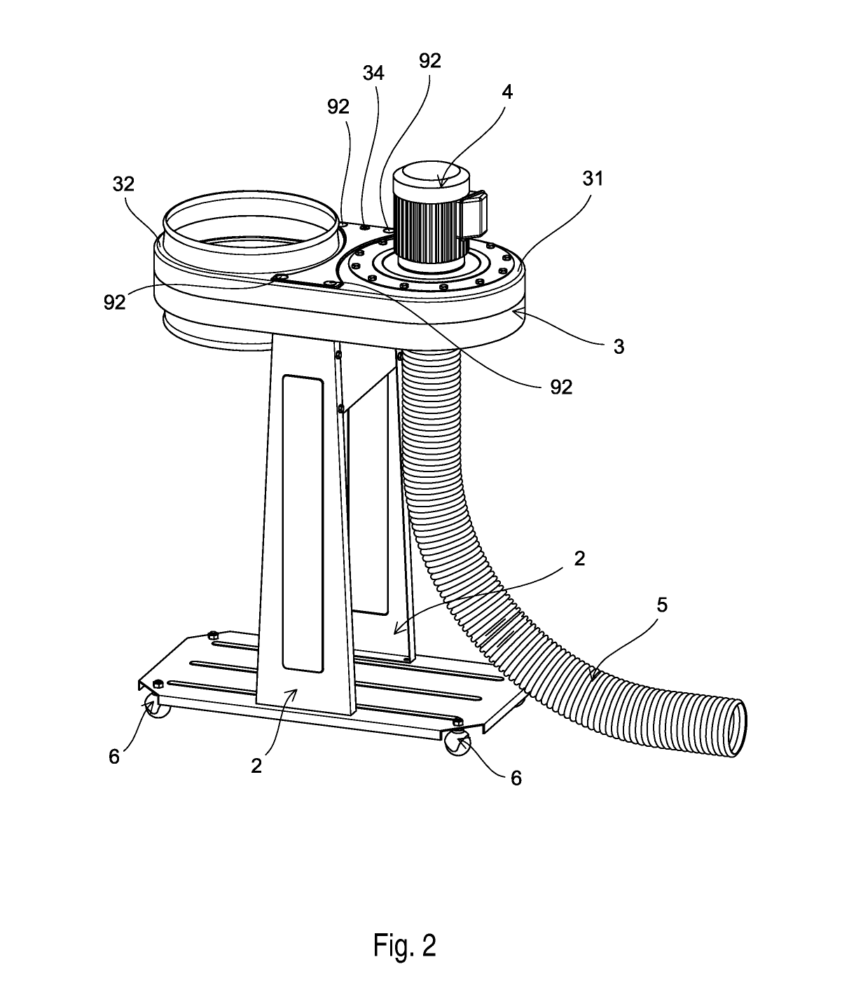

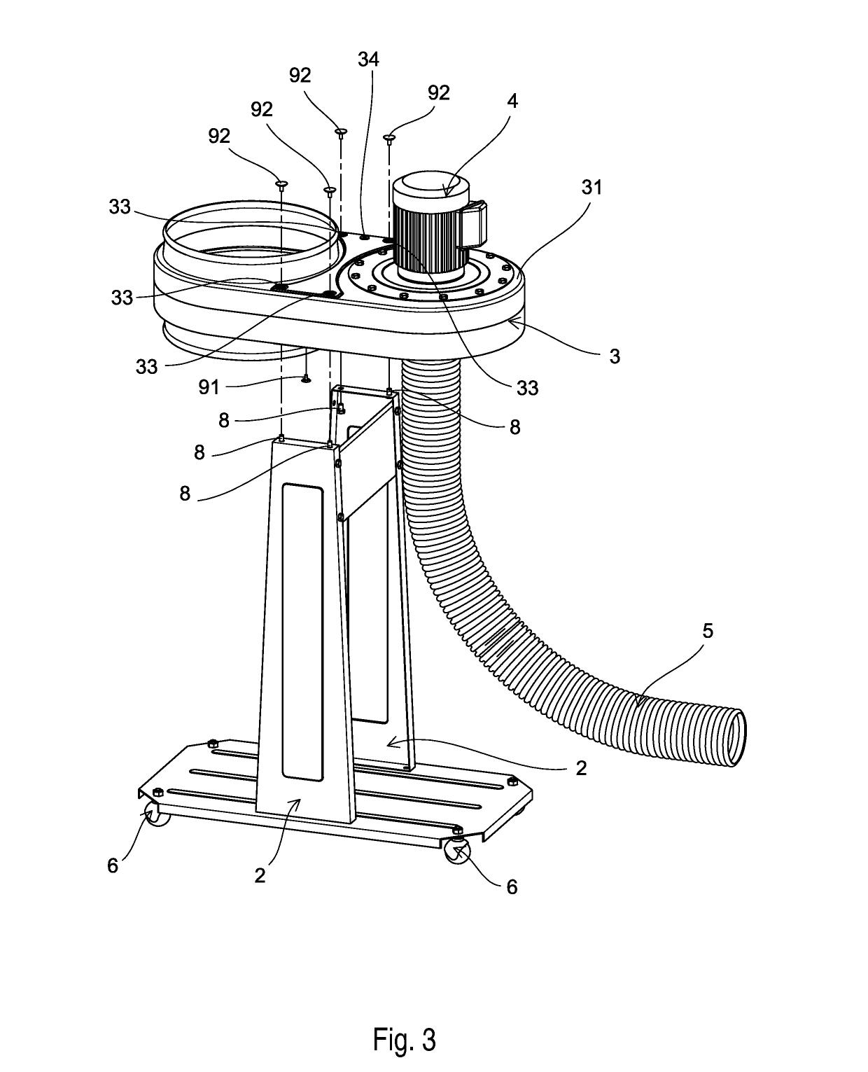

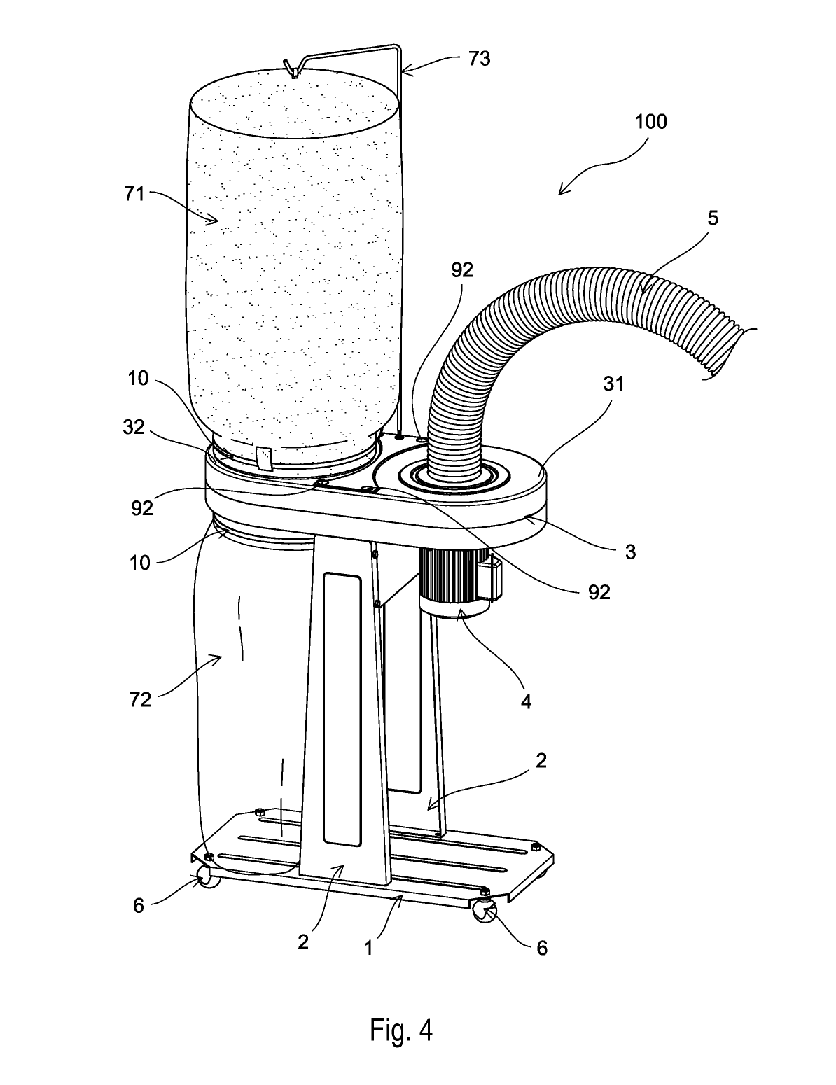

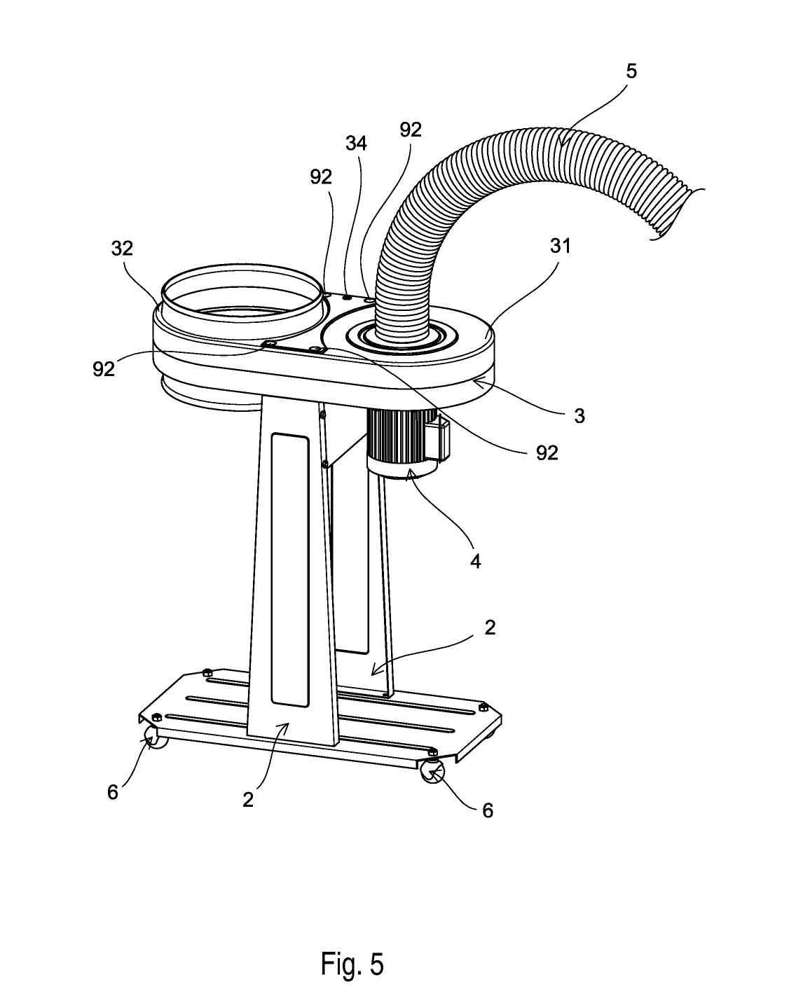

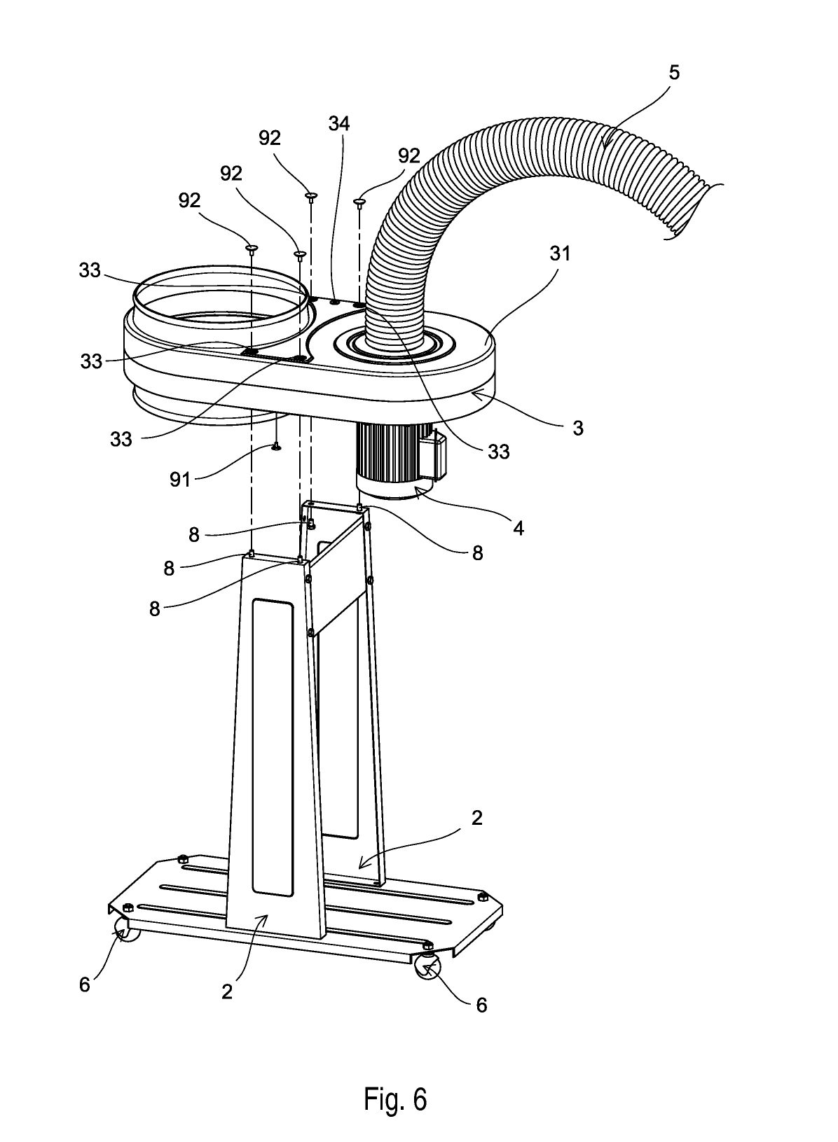

FIG. 1 is a perspective view of a dust collector at a first mode according to an embodiment of present invention. FIG. 2 is a partial perspective view of the dust collector at the first mode according to an embodiment of present invention. FIG. 3 is a partial exploded view of the dust collector at the first mode according to an embodiment of present invention. FIG. 4 is a perspective view of a dust collector at a second mode according to an embodiment of present invention. FIG. 5 is a partial perspective view of the dust collector at the second mode according to an embodiment of present invention. FIG. 6 is a partial exploded view of the dust collector at the second mode according to an embodiment of present invention.

Please refer to FIGS. 1 to 6, the dust collector 100 of this invention may be used for collecting sawdust and wood chips while operating wood working tools, and the dust collector 100 may comprise a base 1, a two supports 2, a hollow removal seat 3, an exhaust fan motor 4, and a conduit 5.

The base 1 may be formed a rectangular shape. The dust collector 100 may further comprise a wheel assembly 6 arranged at lower side of the base 1. The dust collector 100 (or the base 1) may move easily by the wheel assembly 6.

The two supports 2 may be arranged on the base 1 and spaced apart from each other.

The hollow removal seat 3 may be removably arranged on the two supports 2. The seat 3 may include a connecting hole 31 and a connecting ring 32 disposed at opposite two sides thereof.

The exhaust fan motor 4 may be arranged at one side of the connecting hole 31 and communicating with the seat 3.

The conduit 5 may be arranged at the opposite side of the connecting hole 31 and communicating with the seat 3.

The exhaust fan motor 4 is at upper position and the conduit 5 is at lower position while the seat 3 is at a first mode (shown as FIGS. 1 to 3), and the exhaust fan motor 4 is at lower position and the conduit 5 is at upper position while the seat 3 is removed from the two supports 2 and turned around to fix at the two supports 2 and then the seat 5 is at a second mode (shown as FIGS. 4 to 6).

The dust collector 100 of this invention may further comprise an upper cylinder 71, a lower cylinder 72 and an L-shaped bar 73. The L-shaped bar 73 is always arranged at upper side of the seat 3 whatever at the first mode or at the second mode. The upper cylinder 71 may be detachably communicated with the connecting ring 32 and always at the upper side of the seat 3 whatever at the first mode or the second mode. And the lower cylinder 72 may be detachably communicated with the connecting ring 32 and at the lower side of the seat 3 whatever at the first mode or the second mode. The upper cylinder 71 may be made by an air permeable material and hanged by the L-shaped bar 73.

In addition, the upper cylinder 71 and the lower cylinder 72 may be detachably fastened at the connecting ring by a cable tie 10 respectively.

Each side of the seat 3 may include two pairs of screw holes 33 and one insertion hole 34. The two pairs of the screw holes 33 at lower side of the seat 3 may be fixed with the two supports 2 respectively at the first mode or the second mode with two pairs of screws 8. The insertion hole 34 at lower side of the seat 3 at the first mode or the second mode is plugged by an insertion stopper 91. The two pairs of the screw holes 33 at upper side of the seat are plugged by two pairs of stoppers 92, and the insertion hole 34 at the upper side of the seat 3 is provided for fastening the L-shaped bar 73.

Therefore, the sawdust and wood chips may be extracted from the conduit 5 and the seat 3 to the upper cylinder 71 and the lower cylinder 72 by the exhaust fan motor 4. The dust collector 100 of this invention may collect the sawdust and wood chips adjacent to the ceiling or higher locations while the seat 3 is at the second mode. And the dust collector 100 of this invention may also collect the sawdust and wood chips adjacent to the floor or lower locations while the seat 3 is at the first mode. It is easy to operate to turn around the seat 3 to change to the first mode or the second. And the structure is simplified.

What is claimed is:

1. A dust collector for collecting sawdust and wood chips, at least comprising:
a base;
two supports, arranged on the base and spaced apart from each other;
a hollow removal seat, removably arranged on the two supports, the seat including a connecting hole and a connecting ring disposed at opposite two sides thereof;
an exhaust fan motor, arranged at one side of the connecting hole and communicating with the seat; and
a conduit, arranged at opposite side of the connecting hole and communicating with the seat;
wherein the exhaust fan motor is at upper position and the conduit is at lower position while the seat is at a first mode, and the exhaust fan motor is at lower position and the conduit is at upper position while the seat is removed from the two supports and turned around to fix at the two supports and then the seat is at a second mode.

2. The dust collector as claimed in claim 1, further comprising an upper cylinder, a lower cylinder and an L-shaped bar, the L-shaped bar is always arranged at upper side of the seat whatever at the first mode or at the second mode, the upper cylinder is detachably communicated with the connecting ring and always at the upper side of the seat whatever at the first mode or the second mode, and the lower cylinder is detachably communicated with the connecting ring and at the lower side of the seat whatever at the first mode or the second mode, the upper cylinder is made by an air permeable material and hanged by the L-shaped bar.

3. The dust collector as claimed in claim 1, wherein each side of the seat includes two pairs of screw holes and one insertion hole, the two pairs of the screw holes at lower side of the seat are fixed with the two supports respectively at the first mode or the second mode with two pairs of screws, the insertion hole at lower side of the seat at the first mode or the second mode is plugged by an insertion stopper, the two pairs of the screw holes at upper side of the seat are plugged by two pairs of stoppers, and the insertion hole at the upper side of the seat is provided for fastening a L-shaped bar.

4. The dust collector as claimed in claim 2, wherein each side of the seat includes two pairs of screw holes and one insertion hole, the two pairs of the screw holes at lower side of the seat are fixed with the two supports respectively at the first mode or the second mode with two pairs of screws, the insertion hole at lower side of the seat at the first mode or the second mode is plugged by a insertion stopper, the two pairs of the screw holes at upper side of the seat are plugged by two pairs of stoppers, and the insertion hole at the upper side of the seat is provided for fastening the L-shaped bar.

5. The dust collector as claimed in claim 1, further comprises a wheel assembly arranged at the lower side of the base.

6. The dust collector as claimed in claim 2, wherein the upper cylinder and the lower cylinder are detachably fastened at the connecting ring by a cable tie respectively.
